(19) United States
(12) Patent Application Publication
(10) Pub. No.: US 2005/0072047 A1
(43) Pub. Date: Apr. 7, 2005

(54) Tobacco having reduced nicotine and nitrosamines

(76) Inventors: Mark A. Conkling, Chapel Hill, NC (US); Yan Li, Cary, NC (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/943,346

(22) Filed: Sep. 17, 2004

Related U.S. Application Data
(63) Continuation of application No. PCT/US03/10734, filed on Apr. 7, 2003.
(60) Provisional application No. 60/371,635, filed on Apr. 9, 2002.

(51) Int. Cl. A01B 79/00

(52) U.S. Cl. 47/58.1 FV

(57) ABSTRACT

Aspects of the present invention concern tobacco having reduced nicotine and nitrosamines, which is used to manufacture consumer tobacco products, and methods to produce such tobacco. More specifically, embodiments include methods to reduce nicotine and nitrosamines in tobacco crops by applying auxin, auxin analogs, and jasmonate antagonists during the cultivation of such tobacco crops. Tobacco generated using said methods and consumer tobacco products obtained therefrom are also embodiments.

### CROSS-REFERENCE TO RELATED APPLICATIONS

This application is a continuation of international application number PCT/US03/10734, and claims the benefit of priority of international application number PCT/US03/10734 having international filing date of Apr. 7, 2003, designating the United States of America and published in English, which claims the benefit of priority of U.S. provisional patent application No. 60/371,635, filed Apr. 9, 2002; both of which are hereby expressly incorporated by reference in their entireties.

### FIELD OF THE INVENTION

The present invention concerns tobacco having reduced nicotine and nitrosamines and methods to produce such tobacco. More specifically, it is directed to reduction of nicotine and nitrosamines in tobacco, which is cultivated to produce tobacco products for consumers, by applying compounds that modulate gene expression during cultivation of the tobacco.

### BACKGROUND OF THE INVENTION

The health consequences of tobacco consumption are well known but many people continue to use tobacco products. The addictive properties of tobacco products are largely attributable to the presence of nicotine. In addition to being one of the most addictive substances known, nicotine is also a precursor for a large number of carcinogenic compounds present in tobacco and the body.

The addictive properties of tobacco products are also partly attributable to the habitual use of the delivery system (e.g., the oral fixation associated with the act of smoking or chewing tobacco, smoke intake, and taste). Many tobacco-use cessation programs involve the use of nicotine replacement therapy (NRT), wherein various amounts of nicotine are given to the individual as a replacement for tobacco use. Several types of tobacco-use cessation products, which involve NRT, are currently available. For example, nicotine patches, gums, capsules, inhalers, nasal sprays, and lozenges are conventional products of NRT Although these conventional products of NRT may help tobacco users by suppressing the symptoms of nicotine withdrawal, they do little to satisfy the tobacco users' cravings for the habitual use of the delivery system. The factors involved with the habitual use of the delivery system are hereinafter referred to as “secondary factors of addiction.” These secondary factors of addiction involve psychological factors that may not relate to the chemical dependence on nicotine.

In addition to the fact that conventional NRT does little to quell the secondary factors of addiction, NRT can itself be a difficult habit to break. By design, conventional NRT relies on the tobacco user to gradually reduce their daily nicotine intake, while they mentally curb their cravings for the secondary factors of addiction. In practice, however, many program participants only replace the addiction for tobacco with a far more expensive addiction to the NRT product. In some cases, program participants ingest far more nicotine than they would from conventional tobacco use to compensate for lack of fulfillment of the secondary factors of addiction. In other cases, program participants continue using the NRT product for long periods after the initial program has completed.

The intake of large amounts of nicotine and long-term use of NRT raises serious health concerns. In some cases, nicotine overdose may occur with overzealous use of NRT products. Symptoms of nicotine overdose include nausea and/or vomiting, increased watering of mouth (severe), abdominal or stomach pain (severe), diarrhea (severe), pale skin, cold sweat, headache (severe), dizziness (severe), disturbed hearing and vision, tremor, confusion, weakness (severe), extreme exhaustion, fainting, low blood pressure, difficulty in breathing (severe), irregular heartbeat, or convulsions (seizures).

Psychological stress may also occur in individuals using NRT for long periods of time because nicotine releases epinephrine, a hormone that stimulates a stress response in the body. The psychological effects of nicotine include irritability, anxiety, sleep disturbances, nervousness, poor mood and temperament, headaches, fatigue, nausea, and a long-term craving for tobacco. Furthermore, recent research has established that nicotine stimulates the growth of blood vessels during periods of inflammation and promotes angiogenesis, atherosclerosis and tumor growth (Heeschen, et al., Nature Medicine 7:833, 2001). Nicotine may also be a precursor for the endogenous formation of carcinogenic substances such as 4-(methynitrosamino)-1-(3-pyridyl)-1-butanone (NNK) by the body's own metabolic system (Hecht et al., Proc. Nat. Acad. Sci. 97:12493-12497, 2000).

Researchers have developed several approaches to reduce the nicotine content or the nicotine delivery of tobacco products. Some processes, for example, reduce the nicotine content of tobacco after it has been harvested through microbial enzymatic degradation, chemical treatment, or high pressure extraction. (See U.S. Pat. Nos. 4,557,280; 4,561,452; 4,848,373; 4,183,364; and 4,215,706). In view of the foregoing, and notwithstanding the various efforts exemplified in the prior art, there remains a need for tobacco and tobacco products having reduced nicotine and nitrosamines and methods of producing such compositions.

### SUMMARY OF THE INVENTION

Several approaches to produce tobacco and tobacco products having a reduced amount of nicotine and/or nitrosamine have been discovered. By some approaches, tobacco grown in the field (e.g., tobacco crops) are cultivated according to conventional techniques and an auxin, an auxin analog, or a jasmonate antagonist is applied to said tobacco at a specified time and/or age of the plants so as to quell the production of nicotine and/or nitrosamines, specifically tobacco specific nitrosamines (TSNAs). In some embodiments, the auxin, an auxin analog, or a jasmonate antagonist is applied about 21 days before topping said tobacco to about 21 days after topping said tobacco. In desirable embodiments, the auxin, an auxin analog, or a jasmonate antagonist is applied the day of topping and, optionally, a second or third or fourth application of the auxin, an auxin analog, or a jasmonate antagonist is made prior to harvest (e.g., 21 days after topping). Preferably, the auxin, an auxin analog, or a jasmonate antagonist is applied directly to the topped (wounded) portion of the plant with or without a carrier or substance to improve availability or retention of the compound(s), however, it should be understood that the examples above are only a few of the many embodiments encompassed by the invention.

The term “tobacco”, in some contexts, is used in a collective sense to refer to tobacco crops, (e.g., a plurality of tobacco plants grown in the field, i.e., not hydroponically grown tobacco) tobacco plants and parts thereof, including but not limited to, roots, stems, leaves, flowers, and seeds prepared and/or obtained, as described herein. The varieties of tobacco that can be treated according to the disclosed methods include, but are not limited to, dark varieties (e.g., Burley), Flue or Bright varieties (e.g., Virginia flue), Oriental or Turkish varieties, and genetically modified varieties (e.g., Vector 2141). The term “tobacco products” in some contexts refers to consumer tobacco products, including but not limited to, smoking materials (e.g., cigarettes, cigars, pipe tobacco), snuff, chewing tobacco, gum, and lozenges. Preferably these tobacco products are manufactured from tobacco leaves and stems harvested from the tobacco treated as described above and cut, dried, cured, and/or fermented according to conventional techniques in tobacco preparation.

In some embodiments, the tobacco and tobacco products described herein have reduced amounts of nicotine and/or reduced amounts of at least one nitrosamine including, but not limited to, N′-nitrosonornicotine (NNN), N′-nitrosoanatabine (NAT), and N′-nitrosoanabasine (NAB), 4-(N-nitrosomethylamino)-1-(3-pyridyl)-1-butanone (NNK), 4-(N-nitrosomethylamino)-4-(3-pyridyl)-1-butanol (NNA), 4-N-nitrosomethylamino)-1-(3-pyridyl)-1-butanol (NNAL), 4-N-nitrosomethylamino)₄-(3-pyridyl)-1-butanol (iso-NNAL) and 4-(N-nitrosomethylamino)-4-(3-pyridyl)-butanoic acid (iso-NNAC). Desirably, the tobacco and tobacco products of the invention have a reduced amount of at least one TSNA selected from the group consisting of NNN, NNK, NAT and NAB, as compared to tobacco of the same variety and cultivated by conventional techniques or a tobacco product prepared from conventional tobacco.

Another aspect of the present invention concerns methods to substantially prevent, eliminate, or reduce the amount of nicotine and/or nitrosamines in tobacco by application of auxins, auxin analogs, or jasmonate antagonists. In a preferred embodiment, TSNAs including, but not limited to, NNN, NNK, NAT and NAB are reduced in tobacco and or tobacco products by application of auxin, an auxin analog, or a jasmonate antagonist to a mature tobacco plant at up to one month prior to harvest or after topping the tobacco plant. Tobacco products including, but not limited to, smoking materials (e.g., cigarettes, cigars, pipe tobacco), snuff, chewing tobacco, gum, and lozenges prepared from said treated tobacco plants are also embodiments.

More embodiments concern methods to reduce the carcinogenic potential of tobacco products, including cigarettes, cigars, chewing tobacco, snuff and tobacco-containing gum and lozenges. Some methods involve, for example, the preparation of tobacco having a reduced amount of nitrosamines and/or nicotine and the manufacture of tobacco products containing said tobacco by treating said tobacco with an auxin, auxin analog, or jasmonate antagonist, as described above. The tobacco plants, treated in this manner can be harvested, cured, and processed into tobacco products, which exhibit a reduced carcinogenic potential.

Yet another aspect of the invention concerns the reduction of the amount of nitrosamines, preferably TSNAs, more preferably NNN and NNK, and metabolites thereof in humans who smoke, consume or otherwise ingest tobacco. This method is practiced by providing a tobacco product having a reduced amount of tobacco-specific nitrosamines to said humans, prepared according to one of the approaches described herein, thereby lowering the carcinogenic potential of such product in said humans. The tobacco product may be a cigarette, cigar, chewing tobacco, snuff, or a tobacco-containing gum or lozenge.

Another aspect of the invention relates to a series of tobacco-use cessation products and methods for their use. These new cessation products can be tobacco products of the variety with which tobacco consumers are already familiar, including cigarettes, cigars, pipe tobacco, chewing tobacco, snuff, or a tobacco-containing gum or lozenge. The new cessation products feature tobacco created by the methods above and have reduced nicotine and/or nitrosamine content compared to standard tobacco products. Further, these cessation products can be made available with several different levels of nicotine and/or nitrosamine, allowing individuals to switch to tobacco products have lower nicotine and/or nitrosamine content in a gradual, stepwise manner.

### DETAILED DESCRIPTION OF THE INVENTION

Several approaches to create tobacco and tobacco products that have a reduced amount of nicotine and/or nitrosamine have been discovered. By some approaches, tobacco plants, preferably tobacco plants in the field (tobacco crops), are treated with auxin, auxin analogs, or jasmonate antagonists at one or more specific times so as to create tobacco that has reduced nicotine and nitrosamine levels. Tobacco harvested from said treated tobacco plants is then used to prepare a variety of tobacco products. Thus, several aspects of the invention concern the reduction of the nitrosamine content in tobacco by reducing the nicotine content in the tobacco plant through chemical treatment. A copending application entitled “Methods of Reducing the Harmful Effects of Tobacco-Use Cessation Programs” (attorney docket no. VTOB.138PR).

2,4-Dichlorophenoxyacetic acid, commonly known as 2,4-D, is an herbicide and a plant growth regulator. It is used to control broadleaf weeds, grasses and other monocots, woody plants, aquatic weeds, and non-flowering plants. The use of 2,4-D near tobacco crops is largely discouraged as it is known to be particularly injurious to tobacco. “A little triazine or growth regulator-type (2,4-D) herbicide is very likely to injure tobacco.” B. Maksymowicz & G. Palmer, Agriculture & Natural Resources, 158:14 (1995). It has been observed that 2,4-D is most harmful to tobacco plants during the early flowering stage, for example. (See Fung et al., Australian Journal of Experimental Agriculture and Animal Husbandry, 13:330-31 (1973)). It was discovered, however, that nicotine and nitrosamines can be reduced in tobacco by applying auxins, auxin analogs, and/or jasmonate antagonists to mature tobacco plants at a time prior to harvest (e.g., up to one month prior to harvest or after topping the tobacco plant, preferably about 21 days before topping to about 21 days after topping).

Auxins are associated with several physiological responses in plants, such as apical dominance, tropism, root growth, and shoot elongation (for a review, see Bandurski, Plant Hormones, P. J. Davies (ed.) Kluwer Academic Publishers; Netherlands pp. 39-65 (1995)). The primary auxin in plants is indole acetic acid, (IAA). Two synthetic auxin analogs, 2,4-D, and naphthalene-1-acetic acid (NAA) are currently used to induce rooting and to promote fruit development. 2,4-D is also widely used to control broad-leaved weeds, grasses, woody plants, aquatic weeds and non-flowering plants in both crop and non-crop situations. Although, depending on the age of the plants, 2,4-D can be toxic to tobacco (Fung et al., Australian Journal of Experimental Agriculture and Animal Husbandry, 13:328 (1973) and Maksymowicz and Palmer, Online publications, AGR 158 (Apr. 26, 2001)), unexpectedly, mature tobacco plants in the field that are contacted with 2,4-D, exhibit reduced levels of both nicotine and TSNAs, as compared to untreated tobacco plants.

Nicotine and nitrosamines can also be reduced in tobacco by contacting tobacco plants with a jasmonic acid antagonist. Jasmonic acid is a hormone produced by a plant in response to acute wounding (e.g., leaf crushing). Jasmonic acid, also referred to as jasmonate, initiates gene expression in tobacco resulting in the production of nicotine. Tobacco plants in the field that are contacted with jasmonate antagonists such as salicylic acid or tetcyclacis, also exhibit a reduced amount of nicotine and TSNAs, as compared to untreated tobacco plants. Further, contacting plants with molecules that block the octadecanoid pathway leading to jasmonic acid production, such as lipoxygenase inhibitors, can produce tobacco with a reduced nicotine level, and concomitantly, a reduced amount of nitrosamines. The section below describes several approaches to reduce nicotine and nitrosamines in tobacco.

Reducing the Amount Of Nicotine and Nitrosamine in Tobacco

Nicotine is formed primarily in the roots of the tobacco plant and is subsequently transported to the leaves, where it is stored (Tso, Physiology and Biochemistry of Tobacco Plants, pp. 233-34, Dowden, Hutchinson & Ross, Stroudsburg, Pa. (1972)). Classical crop breeding techniques have produced tobacco with lower levels of nicotine, including varieties with as low as 8% of the amount of nicotine found in wild-type tobacco. Although many of the methods described herein can be used with any tobacco variety, low nicotine cultivars are preferred.

Nicotine is produced in tobacco plants by the condensation of nicotinic acid and 4-methylaminobutanal. Two regulatory loci (Nic1 and Nic2) act as co-dominant regulators of nicotine production. Enzyme analyses of roots of single and double Nic mutants show that the activities of two enzymes, quinolate phosphoribosyl transferase (“QPTase”) and putrescence methyl transferase (PMTase), are directly proportional to levels of nicotine biosynthesis. An obligatory step in nicotine biosynthesis is the formation of nicotinic acid from quinolinic acid. QPTase appears to be a rate-limiting enzyme in the pathway supplying nicotinic acid for nicotine synthesis in tobacco. (See, e.g., Feth et al., Planta, 168:402-07 (1986) and Wagner et al., Physiol. Plant., 68:667-72 (1986)). A comparison of enzyme activity in tobacco tissues (root and callus) with different capacities for nicotine synthesis shows that QPTase activity is strictly correlated with nicotine content (Wagner and Wagner, Planta 165:532 (1985)). In fact, Saunders and Bush (Plant Physiol., 64:236 (1979)) showed that the level of QPTase in the roots of low nicotine mutants is proportional to the levels of nicotine in the leaves.

As discussed above, nitrosamines, especially TSNAs, and nicotine contribute significantly to the carcinogenic potential and addictive properties of tobacco and tobacco products. Thus, tobacco and tobacco products that have a reduced amount of nitrosamines, especially TSNAs, and nicotine have tremendous utility. Without wishing to be bound by any particular theory, it is contemplated that the generation of tobacco plants, tobacco, and tobacco products that have a reduced amount of nicotine will also have a reduced amount of nitrosamine. That is, by removing nicotine from tobacco plants, tobacco, and tobacco products, the alkaloid substrate for nitrosamine formation, in particular the substrate for TSNA formation, is also removed. Unexpectedly, the methods described herein can be used to not only produce tobacco with a reduced addictive potential but also to produce a tobacco that has a reduced carcinogenic potential.

It should be emphasized that the word “reduced,” or the phrase “a reduced amount” is intended to refer to an amount of nicotine and or nitrosamine in a treated tobacco plant, tobacco, or a tobacco product that is less than what would be found in a tobacco plant, tobacco, or a tobacco product from the same variety of tobacco processed in the same manner, which has not been treated for reduced nicotine and/or nitrosamines. Thus, in some contexts, wild-type tobacco of the same variety that has been processed in the same manner is used as a control by which to measure whether a reduction in nicotine and/or nitrosamine has been obtained by the inventive methods described herein.

Wild type tobacco varies significantly in the amount of nitrosamines and nicotine depending on the variety and the manner it is grown, harvested, and cured. For example, a typical cured Burley tobacco leaf has about 30,000 parts per million (ppm) nicotine and about 8,000 parts per billion (ppb) nitrosamine; a typical Flue Cured Burley leaf has about 20,000 ppm nicotine and about 300 ppb nitrosamine; and a typical Oriental cured leaf has about 10,000 ppm nicotine and about 100 ppb nitrosamines. A tobacco plant or portion thereof having a reduced amount of nicotine and/or nitrosamines, according to the invention, can have no detectable nicotine and/or nitrosamines, or may contain some detectable amounts of one or more nitrosamines and/or nicotine so long as the amount of nicotine and/or nitrosamine is less than that found in a control plant of the same variety. That is, a Burley tobacco leaf treated according to the inventive methods described herein can have a reduced amount of nicotine between about 0 and about 30,000 ppm nicotine and about 0 and about 8,000 ppb nitrosamine, desirably between about 0 and about 20,000 ppm nicotine and about 0 and about 6,000 ppb nitrosamine, more desirably between about 0 and about 10,000 ppm nicotine and about 0 and about 5,000 ppb nitrosamine, preferably between about 0 and about 5,000 ppm nicotine and about 0 and about 4,000 ppb nitrosamine, more preferably between about 0 and about 2,500 ppm nicotine and about 0 and about 2,000 ppb nitrosamine and most preferably between about 0 and about 1,000 ppm nicotine and about 0 and about 1,000 ppb nitrosamine. Embodiments of Burley leaf prepared by the methods described herein can also have between about 0 and about 500 ppm nicotine and about 0 and about 500 ppb nitrosamine and some embodiments of Burley leaf prepared by the methods described herein have virtually no detectable amount of nicotine or nitrosamine.

Similarly, a flue cured Burley tobacco leaf treated according to the methods described herein can have a reduced amount of nicotine between about 0 and about 20,000 ppm nicotine and about 0 and about 300 ppb nitrosamine, desirably between about 0 and about 15,000 ppm nicotine and about 0 and about 250 ppb nitrosamine, more desirably between about 0 and about 10,000 ppm nicotine and about 0 and about 200 ppb nitrosamine, preferably between about 0 and about 5,000 ppm nicotine and about 0 and about 150 ppb nitrosamine, more preferably between about 0 and about 2,500 ppm nicotine and about 0 and about 100 ppb nitrosamine and most preferably between about 0 and about 1,000 ppm nicotine and about 0 and about 50 ppb nitrosamine. Embodiments of flue cured Burley leaf prepared by the methods described herein can also have between about 0 and about 500 ppm nicotine and about 0 and about 25 ppb nitrosamine and some embodiments of flue cured Burley leaf prepared by the methods described herein have virtually no detectable amount of nicotine or nitrosamine.

Further, an Oriental cured tobacco leaf treated according to the methods described herein can have a reduced amount of nicotine between about 0 and about 10,000 ppm nicotine and about 0 and about 100 ppb nitrosamine, desirably between about 0 and about 7,000 ppm nicotine and about 0 and about 75 ppb nitrosamine, more desirably between about 0 and about 5,000 ppm nicotine and about 0 and about 50 ppb nitrosamine, preferably between about 0 and about 3,000 ppm nicotine and about 0 and about 25 ppb nitrosamine, more preferably between about 0 and about 1,500 ppm nicotine and about 0 and about 10 ppb nitrosamine and most preferably between about 0 and about 500 ppm nicotine and no nitrosamine. Embodiments of flue cured Burley leaf prepared by the methods described herein can also have between about 0 and about 250 ppm nicotine and no nitrosamine and some embodiments of flue cured Burley leaf prepared by the methods described herein have virtually no detectable amount of nicotine or nitrosamine.

In some contexts, the phrase “a reduced amount of nicotine and/or nitrosamines” refers to tobacco plants, tobacco and tobacco products, which have less nicotine and/or nitrosamines by weight than the same variety of tobacco grown, processed, and cured in the same way. For example, wild type tobacco has approximately 14% dry weight nicotine and approximately 0.2%-0.8% dry weight nitrosamines depending on the manner it was grown, harvested and cured. A typical cigarette has 11 mg of nicotine and 2.2 mg of nitrosamines. Thus, the tobacco plants, tobacco and tobacco products of the invention can have, in dry weight for example, less than 0.01%, 0.015%, 0.02%, 0.025%, 0.03%, 0.035%, 0.04%, 0.045%, 0.05%, 0.055%, 0.06%, 0.065%, 0.07%, 0.075%, 0.08%, 0.085%, 0.09%, 0.095%, 0.1%, 0.15%, 0.175%, 0.2%, 0.225%, 0.25%, 0.275%, 0.3%, 0.325%, 0.35%, 0.375%, 0.4%, 0.425%, 0.45%, 0.475%, 0.5%, 0.55%, 0.6%, 0.65%, 0.7%, 0.75%, 0.8%, 0.85%, 0.9%, 0.95%, and 1.0% nicotine and less than 0.01%, 0.015%, 0.02%, 0.025%, 0.03%, 0.035%, 0.04%, 0.045%, 0.05%, 0.055%, 0.06%, 0.065%, 0.07%, 0.075%, and 0.08% nitrosamines.

Additionally, a cigarette of the invention can have, for example, less than 0.1 mg, 0.15 mg, 0.2 mg, 0.25 mg, 0.3 mg, 0.35 mg, 0.4 mg, 0.45 mg, 0.5 mg, 0.55 mg, 0.6 mg, 0.65 mg, 0.7 mg, 0.75 mg, 0.8 mg, 0.85 mg, 0.9 mg, 0.95 mg, 1.0 mg, 1.1 mg, 1.15 mg, 1.2 mg, 1.25 mg, 1.3 mg, 1.35 mg, 1.4 mg, 1.45 mg, 1.5 mg, 1.55 mg, 1.6 mg, 1.65 mg, 1.7 mg, 1.75 mg, 1.8 mg, 1.85 mg, 1.9 mg, 1.95 mg, 2.0 mg, 2.1 mg, 2.15 mg, 2.2 mg, 2.25 mg, 2.3 mg, 2.35 mg, 2.4 mg, 2.45 mg, 2.5 mg, 2.55 mg, 2.6 mg, 2.65 mg, 2.7 mg, 2.75 mg, 2.8 mg, 2.85 mg, 2.9 mg, 2.95 mg, 3.0 mg, 3.1 mg, 3.15 mg, 3.2 mg, 3.25 mg, 3.3 mg, 3.35 mg, 3.4 mg, 3.45 mg, 3.5 mg, 3.55 mg, 3.6 mg, 3.65 mg, 3.7 mg, 3.75 mg, 3.8 mg, 3.85 mg, 3.9 mg, 3.95 mg, 4.0 mg, 4.1 mg, 4.15 mg, 4.2 mg, 4.25 mg, 4.3 mg, 4.35 mg, 4.4 mg, 4.45 mg, 4.4 mg, 4.45 mg, 4.5 mg, 4.55 mg, 4.6 mg, 4.65 mg, 4.7 mg, 4.75 mg, 4.8 mg, 4.85 mg, 4.9 mg, 4.95 mg, 5.0 mg, 5.5 mg, 5.7 mg, 6.0 mg, 6.5 mg, 6.7 mg, 7.0 mg, 7.5 mg, 7.7 mg, 8.0 mg, 8.5 mg, 8.7 mg, 9.0 mg, 9.5 mg, 9.7 mg, 10.0 mg, 10.5 mg, 10.7 mg, and 11.0 mg nicotine and less than 0.1 mg, 0.15 mg, 0.2 mg, 0.25 mg, 0.3 mg, 0.35 mg, 0.4 mg, 0.45 mg, 0.5 mg, 0.55 mg, 0.6 mg, 0.65 mg, 0.7 mg, 0.75 mg, 0.8 mg, 0.85 mg, 0.9 mg, 0.95 mg, 1.0 mg, 1.1 mg, 1.15 mg, 1.2 mg, 1.25 mg, 1.3 mg, 1.35 mg, 1.4 mg, 1.45 mg, 1.5 mg, 1.55 mg, 1.6 mg, 1.65 mg, 1.7 mg, 1.75 mg, 1.8 mg, 1.85 mg, 1.9 mg, 1.95 mg, 2.0 mg, 2.1 mg, 2.15 mg, 2.2 mg nitrosamine.

Any method for reducing nicotine levels in a plant will be suitable for producing tobacco that has a reduced amount of nicotine and nitrosamines, especially TSNAs. More specifically, any method for reducing endogenous levels of nicotine in a plant will be suitable for producing tobacco substantially free of nitrosamines, especially TSNAs. Any method that reduces levels of other alkaloids including norniticotine, will likewise be suitable for producing tobacco substantially free of nitrosamines, especially TSNAs. A preferred method of producing tobacco having a reduced amount of nicotine and nitrosamines, especially TSNAs, involves treating at least one tobacco plant with an auxin, auxin analog, or jasmonate antagonist. The section below describes the use of auxins and/or auxin analogs to produce tobacco and tobacco products having low levels of nicotine and TSNAs, as compared to similar age tobacco, cultivated under similar growing conditions, which was not treated with auxin or an auxin analog.

Auxin

Auxins are naturally occuring plant regulatory molecules. Additions of hormones such as auxins have long been used as a component of the culture medium in the process of plant tissue culture. Studies on tobacco callus growth have shown that addition of auxins or their analogs to the tissue culture medium appear to have an effect on the regulation of nicotine content (Saunders, Drug Info. Jour., 32:609 (1998)). The most common endogenous auxin is indole-3-acetic acid (IAA). In addition to IAA, there appear to be many auxin derivatives present endogenously in various species. Among these auxin derivatives are the AA conjugates to various sugars and amino acids. Auxins may also be linked to polypeptides. Among the auxin molecules that have been isolated are:
a) The indole-3-acetyl derivatives, such as methyl indole-3-acetate, ethyl indole-3-acetate, indole-3-acetamide, 2-O-(indole-3-acetyl)myo-inositol, 5-O-β-L-arabinopyranosyl-2-O-indole-3-acetyl-myo-inositol, 5-O-β-D-galactopyranosyl-2-O-indole-3-acetyl-myo-inositol, 2-O-(indole-3-acetyl)-D-glucopyranose, 4-O-(indole-3-acetyl)-D-glucopyranose, 6-O-(indole-3-acetyl)-D-glucopyranose, di-O-(indole-3-acetyl)-myo-inositol, and tri-O-(indole-3-acetyl)-myo-inositol;
b) The chloroindoles such as 4-chloroindole-3-acetic acid, methyl 4-chloroindole-3-acetate, monomethyl 4-chloroindole-3-acetyl-L-aspartate, α-N-carbomethoxyacetyl-D-4-chlorotryptophan, and α-N-carboethoxyacetyl-D-4-chlorotryptophan;
c) The indole-3-acetonitriles such as: indole-3-acetonitrile, 4-methoxyindole-3-acetonitrile, and 1-methoxyindole-3-acetonitrile;
d) The indole derivatives indole-3-ethanol, indole-3-acetaldehyde, indole-3-acetoxime, tryptamine, α-N-malonyl-D-tryptophan, indole-3-carboxaldehyde, and indole-3-carboxylic acid;
e) Other indole complexes, such as indole-3-methylglucosinolate, 1-methoxyindole-3-methylglucosinolate, and 1-sulphoindole-3-methylglucosinolate

Additionally, other compounds exist that may have auxin activity, such as indole-3-acetylaspartate, indole-3-acetyl-1-b-glucose, phenylacetic acid, phenylacetonitrile. These compounds are often referred to as auxin analogs.

A few more synthetic auxins by brand name: 2,4-D, 2,4-D (amine or LV ester), 2,4-DB, Clopyralid, dicamba (3,6-dichloroanisic acid), Banvel (Dicamba-DMA salt), Clarity (Dicamba DGA salt), 2-methyl-4-chlorophenoxyacetic acid (MCPA), picloram (4-amino-3,5,6-trichloropicolinic acid), triclopyr, and flumetsulam. It is contemplated that any or all of the auxins or auxin analogs provided above alone or in combination can be used to decrease or reduce the levels of nicotine and/or nitrosamine in tobacco and tobacco products. The section below describes in greater detail how to use auxins and auxin analogs to reduce the level of nicotine and TSNA in tobacco.

Using Auxins and Auxin Analogs

Several methods may be used to contact a tobacco plant identified as one in need of nicotine reduction, preferably a crop or field of topped tobacco, with the auxin and/or auxin analog. Examples of applications of the auxin analog 2,4-D as a growth stimulator may be found in U.S. Pat. No. 4,519,163 to Bonner, U.S. Pat. No. 4,274,861 to Henderson, and U.S. Pat. No. 3,967,953 to MacMurray. Preferably, plants are sprayed with an aqueous solution of the auxin or auxin analog, particularly covering the wounded portions of the plants (e.g., topped portion). Inert ingredients such as surfactants or adherents can be added to the solution to alter the availability to the plant or retention of the compound. The auxin or auxin analog can also be applied directly to the soil surrounding the plant in either a solution or as a dry powder. In another embodiment, a composition containing the auxin and/or auxin analog is applied as part of a slowly dissolving cake of material placed in or on top of the soil.

The range of auxin or auxin analog to apply depends on the time of application and the variety of tobacco plant. The appropriate amount can also depend on growing conditions (e.g., nitrogen in the soil). Suitable amounts can be determined experimentally by applying various amounts of 2,4-D to various age crops growing in test fields at several locations. In many embodiments, for example, the range of auxin or auxin analog to apply will be between about 0.005 ppm and about 200 ppm. That is, the amount of auxin or auxin analog is about: 0.005 ppm, 0.007 ppm, 0.01 ppm, 0.02 ppm, 0.05 ppm, 0.07 ppm, 0.1 ppm, 0.2 ppm, 0.5 ppm, 0.7 ppm, 1 ppm, 2 ppm, 5 ppm, 7 ppm, 10 ppm, 20 ppm, 50 ppm, 75 ppm, 100 ppm, 125 ppm, 150 ppm, 175 ppm, or 200 ppm or more. It should be understood that the range of composition to apply may also depend on environmental conditions such as soil type, salinity, drought, temperature, and nutrient levels. In many embodiments, any auxin analog, including the salt of an auxin analog, can be used. Additionally, combinations of the auxin and/or auxin analog with alcohols can be used. As described above, the composition can also include inert ingredients, surfactants, or adherents and, in these embodiments, any suitable surfactant can be used, such as, for example Tween 20, as well as any of the many well known adhering agents.

In some embodiments, the amount of auxin and/or auxin analog contacted with a tobacco plant identified as one in need of nicotine reduction, a topped tobacco plant, for example, is an amount sufficient to adjust the concentration of auxin in said topped tobacco plant or portion thereof to a level that is about equivalent to that of a tobacco plant of the same variety grown under similar conditions that has not been topped. In some cases, the level of auxin in the treated, topped tobacco plant will be slightly lower than that of an untreated, not topped tobacco plant and in other cases the level of auxin in the treated, topped tobacco plant will be slightly higher than that of an untreated, not topped tobacco plant. Thus, embodiments of the invention are topped tobacco plants comprising an amount of auxin (conjugated and unconjugated) that is substantially similar to that of tobacco plants of the same variety and grown under similar conditions that were not topped. Tobacco and tobacco products generated from said topped tobacco plants are also embodiments of the invention. Related embodiments include tobacco plants (and tobacco products generated therefrom) that comprise an amount of unconjugated or conjugated auxin that is substantially similar to that of tobacco plants of the same variety and grown under similar conditions that were not topped.

In determining the levels of auxin or auxin analog in a treated, topped tobacco plant as compared to an untreated, not topped tobacco plant, plants of the same age and cultivated in similar growing conditions are preferably compared. The analysis of the level of auxin is also preferably made in approximately the same plant tissue. That is, the same leaf or internode, as numbered from the apex, is preferably analyzed in both the treated, topped tobacco plant as the untreated, not topped tobacco plant because the levels of auxin in tobacco plants decrease as the distance from the apex increases. (See e.g., Sitbon et al., Physiol. Plant 98:677 (1996) and Sitbon et al., Plant Physiol. 99:1062 (1992).)

By way of example, some embodiments include tobacco and tobacco products generated therefrom obtained from a topped tobacco plant, which has been treated with auxin or an auxin analog, wherein the amount of auxin or auxin analog (conjugated and unconjugated) in said treated, topped tobacco plant or portion thereof is about 5 to about 40 ng/g fresh weight (FW) or dry weight (DW). That is, in some embodiments the amount of auxin or auxin analog in said treated, topped tobacco plant or portion thereof is about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 ng/g FW or DW.

In particular embodiments of topped, treated tobacco plants, for example, the amount of auxin (conjugated and unconjugated) in leaf 2 or 3 (as measured from the apex) from said plant is about 21 ng/g FW, in leaf 7 about 6 ng/g FW, at internode 1-3 about 31 ng/g FW, and at internode 7-8 about 25 ng/g FW. In other embodiments of topped, treated tobacco plants, the amount of free IAA at the apex is about 52 ng/g FW and conjugated IAA is about 25 ng/g FW, at leaf 1-3 about 30 ng/g FW free IAA and 16 ng/g FW conjugated IAA, at leaf 7 about 20 ng/g FW free IAA and 26 ng/g FW conjugated IAA, at internode 1-3 about 60 ng/g FW free IAA and 30 ng/g FW conjugated IAA, and at internode 5 about 53 ng/g FW free IAA and 15 ng/g FW conjugated IAA.

In other embodiments, the amount of auxin in said treated, topped tobacco plant or portion thereof is greater than that untreated, not topped tobacco or portion thereof. That is, for example, embodiments include tobacco and tobacco products generated therefrom obtained from a topped tobacco plant, which has been treated with auxin or an auxin analog, wherein the amount of auxin or auxin analog (conjugated and unconjugated) in said treated, topped tobacco plant or portion thereof is greater than 40 ng/g fresh weight (FW) or dry weight (DW). That is, in some embodiments the amount of auxin or auxin analog in said treated, topped tobacco plant or portion thereof is about 41, 42, 43, 44, 44, 45, 46, 47, 48, 49, 50, 55, 60, 65, 70, 75, 80, 85, 90, or 100 ng/g FW or DW.

In some embodiments of topped, treated tobacco plants, for example, the amount of auxin (conjugated and unconjugated) in leaf 2 or 3 (as measured from the apex) from said plant is can be between 21-100 ng/g FW, in leaf 7 between 6-100 ng/g FW, at internode 1-3 between 31-100 ng/g FW, and at internode 7-8 between 25-100 ng/g FW. In other embodiments of topped, treated tobacco plants, the amount of free IAA at the apex is between 52-100 ng/g FW and conjugated IAA is between 25-100 ng/g FW, at leaf 1-3 between 30-100 ng/g FW free IAA and between 16-100 ng/g FW conjugated IAA, at leaf 7 between 20-100 ng/g FW free IAA and between 26-100 ng/g FW conjugated IAA, at internode 1-3 between 60-100 ng/g FW free IAA and between 30-100 ng/g FW conjugated IAA, and at internode 5 between 53-100 ng/g FW free IAA and between 15-100 ng/g FW conjugated IAA.

Topping or decapitation results in tobacco plants and potions thereof that have approximately 50% of the auxin present prior to topping or decapitation. (See e.g., Wolbang and Ross, Planta 214:13 (2001)). Accordingly, some embodiments of the invention include topped tobacco plants, portions thereof, and tobacco products generated therefrom, wherein the level of auxin in said plants or portions thereof, which have been treated with an auxin and/or auxin analog, is about 51% to 100% the amount of auxin in the plant or portion thereof prior to topping or is about 51% to 100% the amount of auxin present in a similar age tobacco plant or portion thereof that has not been treated with auxin or an auxin analog and has not been topped but has been cultivated under growing conditions that are similar to that of the treated, topped tobacco plant. That is, the level of auxin in said topped tobacco plant or portion thereof, which was treated with auxin and/or an auxin analog can be between 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100% the amount of auxin present in a similar age tobacco plant or portion thereof that has not been treated with auxin or an auxin analog and has not been topped but has been cultivated under growing conditions that are similar to that of the treated, topped tobacco plant. The section below describes the use of jasmonate antagonists to reduce the level of nicotine and TSNA in tobacco plants and tobacco and tobacco products made from said jasmonate anatagonist-treated tobacco plants.

Jasmonate Antagonists

A “jasmonate antagonist” may be described as a molecule that interferes with a biosynthetic step such that jasmonate is not synthesized in the plant or is not made available to the plant. A “jasmonate antagonist” can also be a compound that blocks a receptor for jasmonic acid, thereby reducing the activity of jasmonic acid. Accordingly, a “jasmonate antagonist” may be characterized as functioning to decrease levels or availability of jasmonate, jasmonic acid, or methyl jasmonate in the plant. A “jasmonate antagonist” also includes molecules that prevent or inhibit the increase in jasmonic acid levels that is often associated with wounding or other stress responses and molecules that have an inhibitory effect on the activity of lipoxygenase, an enzyme in the pathway leading to jasmonic acid synthesis. A jasmonic acid antagonist may also be an inhibitor of any step in the octadecanoid pathway, such that jasmonic acid levels are reduced.

In some embodiments, molecules that interfere with the jasmonate signaling pathway or with general plant response to herbivory and insect feeding are used to reduce nicotine and/or nitrosamine levels in tobacco. This jasmonic acid pathway can be blocked by non-steroidal anti-inflammatory drugs (NSAIDS) such as ibuprofen, naproxen, and salicylic acid, for example. Additionally, the jasmonic acid pathway can be interrupted by applying a compound containing Benzo[1,2,3]thiadiazole-7-carbothioic acid (commercially available from Syngenta). Benzo[1,2,3]thiadiazole-7-carbothioic acid containing compounds include acibenzolar-S-methyl, acibenzolar S-methyl fenopropidin or actigard 50 wp or bion. Actigard 50 wp has been applied to Burley tobacco to control blue mold. (See Nesmith, “Actigard—A New Blue Mold Control Tool”, Tobacco Disease Article From KY Pest News (online publication)).

The amount of jasmonate antagonist to apply depends on the time of application and the variety of tobacco plant. The appropriate amount can also depend on growing conditions (e.g., nitrogen in the soil). Preferably, the amount of jasmonate antagonist to apply is an amount sufficient to reduce the level of jasmonic acid in a topped, treated tobacco plant or portion thereof to a level approximately equivalent to an untreated and not topped tobacco plant, or portion thereof, of similar age and cultivated under similar growing conditions.

The level of jasmonic acid in the treated, topped tobacco plant can be slightly higher than that of an untreated, not topped tobacco plant and in other cases the level of jasmonic acid in the treated, topped tobacco plant can be slightly lower than that of an untreated, not topped tobacco plant. Thus, embodiments of the invention are topped tobacco plants comprising an amount of jasmonic acid that is substantially similar to that of tobacco plants of the same variety and grown under similar conditions that were not topped. Tobacco crops and tobacco products generated from said topped tobacco plants are also embodiments of the invention. Related embodiments include tobacco crops and plants (and tobacco products generated therefrom) that comprise an amount of jasmonic acid that is substantially similar to that of tobacco plants of the same variety and grown under similar conditions that were not topped.

As above, in determining the levels of jasmonic acid in a treated, topped tobacco plant as compared to an untreated, not topped tobacco plant, plants of the same age and cultivated in similar growing conditions are preferably compared. Additionally, one preferably analyzes the level of jasmonic acid in approximately the same plant tissue. Typically, within 90 minutes after wounding a tobacco plant, the amount of jasmonic acid increases to 5-500 ng/g. (See e.g., Kahl et al., Planta 210:336 (2000).) Accordingly, some embodiments of the invention include tobacco crops, tobacco plants, and tobacco products obtained from topped tobacco plants, which have been treated with a jasmonic acid antagonist, wherein the amount of jasmonic acid in said treated, topped tobacco plants or portion thereof is about 0 to about 500 ng/g fresh weight (FW) or dry weight (DW). That is, in some embodiments the amount of jasmonic acid in said treated, topped tobacco plant or portion thereof is about 1, 2, 3, 4, 5, 10, 20, 30, 40, 50, 100, 125, 150, 175, 200, 250, 300, 350, 400, 450, and 500 ng/g FW or DW so long as said amount is less than the amount of jasmonic acid present in tobacco plant of the same age that has not been topped and was cultivated using similar growing conditions.

The application of suitable amounts of jasmonate antagonist can be determined experimentally by applying various amounts to various age crops growing in test fields at several locations. In many embodiments, the range of jasmonate antagonist will be between about 0.005 ppm and about 200 ppm. That is, the amount of jasmonate antagonist can be about: 0.005 ppm, 0.007 ppm, 0.01 ppm, 0.02 ppm, 0.05 ppm, 0.07 ppm, 0.1 ppm, 0.2 ppm, 0.5 ppm, 0.7 ppm, 1 ppm, 2 ppm, 5 ppm, 7 ppm, 10 ppm, 20 ppm, 50 ppm, 75 ppm, 100 ppm, 125 ppm, 150 ppm, 175 ppm, or 200 ppm or more. It should be understood that the range of composition to apply may also depend on environmental conditions such as soil type, salinity, drought, temperature, and nutrient levels. In many embodiments, any jasmonate antagonist can be used. Additionally, combinations of the jasmonate antagonist with alcohols can be used. The composition can include inert ingredients, surfactants, or adherents. Any suitable surfactant can be used, such as, for example Tween 20, as well as any of the many well known adhering agents. The jasmonate antagonist can be present in an aqueous solution, in an emulsion, or as a dry powder.

Other Molecules Acting as Jasmonate Antagonists

In other embodiments of the present invention, any molecule that induces the plant pathogenic defense response may be capable of inducing salicylic acid, which may interfere with jasmonate-induced responses. Plants can be pre-treated with salicylic acid several hours before the commencement of the topping procedure to ameliorate the jasmonic acid response, thus decreasing nicotine levels. Salicylic acid is a systemic signal and an inducer of pathogenesis-related proteins in virus-infected tobacco, and an inducer of acquired resistance (Uknes, S., et al., Plant Cell, 4:645-656 (1992)). Salicylic acid appears to play a signal function in the pathways that lead to the defense response. Further, endogenous levels of salicylic acid increase after immunization with elicitors.

The term “salicylic acid compound(s)” as used herein is meant to encompass salicylic acid and benzoic acid analogues thereof. The term includes, but is not limited to, such compounds as 2-hydroxybenzoic acid (salicylic acid); (acetylsalicylic acid) (aspirin); methyl salicylate; 2,6-dihydroxybenzoic acid; 3-hydroxybenzoic acid; 4-hydroxybenzoic acid; 2,3-dihydroxybenzoic acid; 2,4-dihydroxybenzoic acid and 2,5-dihydroxybenzoic acid. Other salicylic acid derivatives include bromosaligenin, fendosal, glycol salicylate, mesalamine, 1-napthyl salicylate, olsalazine, and sulfasalazine.

As described above, one way to increase SA levels in plants involves contacting the plants with pathogens. This may not be a commercially useful strategy, however, because eliciting plant defenses signals such as SA by plant-pathogen contact can weaken or kill plants. The use of inducers that generate responses leading to increased endogenous SA levels and subsequent jasmonate antagonism without causing disease in the plant, however, can be used. This can be achieved in a number of ways, including: 1) contacting the plant with a compound derived from a bacterium or virus, 2) contacting the plant with an amount of intact bacteria or virus which results in an increase in SA levels, and 3) contacting the plant with a crude bacterial or viral extract or supernatant. In one embodiment, preparations of bacterial of viral material, preferably treated so as not to be damaging to the plant, can be applied to the leaves or to the soil surrounding the plant to induce the endogenous production of salicylic acid, which then inhibits jasmonic acid synthesis and its corresponding pathways.

Wounding or chewing insect attack triggers the octadecanoic acid signaling pathway, which leads to the synthesis of the plant regulatory molecule jasmonic acid. The enzymes involved in the octadecanoid signaling pathway in plants are reviewed in Schaller, J. Exp. Bot., 52:11 (2001). It is possible to block the pathway leading to jasmonic acid by adding molecules that function to block this pathway to jasmonic acid. In addition to salicylic acid and its derivatives, compounds that function to decrease nicotine and/or nitrosamine levels by blocking pathways leading to jasmonic acid include: Esculentin, salicylhydroxamic acid, 5,8,11-eicosatriynoic acid, 5,8,11,14-eicosatriynoic acid, ketoconazole, baicalein, caffeic acid, alpha-pentyl-3-(2-quinolinylmethoxy)benzenemethanol, curcumin, ibuprofen, and naproxen. Many of these molecules are well known in mammalian research as inhibitors of lipoxygenase activity, and may also be effective in inhibitory jasmonic acid accumulation in plants. Nonsteroidal anti-inflammatory drugs (e.g., ibuprofen, naproxen, and flurbiprofen) can be used to antagonize the wound response. Naproxen has been used to inhibit lipoxygenase activity in potato (Kolomiets, et al., Plant Cell, 13:613 (2001)) and soybean (Creelman, Plant Physiol, 99:1258 (1992))). Several other lipoxygenase inhibitors have been found to be effective in plants (Sircar, Prostaglandins, 25:393 (1983)). Furthermore, other molecules such as tetcyclacis (or tetcyclacis) have been found to inhibit jasmonic acid levels in plants. Schweizer, et al., Plant Physiol., 114:79 (1997).

The range of lipoxygenase inhibitor to apply depends on the time of application and the variety of tobacco plant. The appropriate amount can also depend on growing conditions (e.g., nitrogen in the soil). Suitable amounts can be determined experimentally by applying various amounts of lipoxygenase inhibitor (e.g., Naproxen) to various age crops growing in test fields at several locations. In many embodiments, the range of lipoxygenase inhibitor will be between about: 0.005 ppm and about 200 ppm. That is, the amount of lipoxygenase inhibitor can be about 0.005 ppm, 0.007 ppm, 0.01 ppm, 0.02 ppm, 0.05 ppm, 0.07 ppm, 0.1 ppm, 0.2 ppm, 0.5 ppm, 0.7 ppm, 1 ppm, 2 ppm, 5 ppm, 7 ppm, 10 ppm, 20 ppm, 50 ppm, 75 ppm, 100 ppm, 125 ppm, 150 ppm, 175 ppm, or 200 ppm or more. It should be understood that the range of composition to apply may also depend on environmental conditions such as soil type, salinity, drought, temperature, and nutrient levels. In many embodiments, any lipoxygenase inhibitor can be used. Additionally, combinations of the lipoxygenase with alcohols can be used. The composition can include inert ingredients, surfactants, or adherents. Any suitable surfactant can be used, such as, for example Tween 20, as well as any of the many well known adhering agents. The lipoxygenase inhibitor can be present in an aqueous solution, in an emulsion, or as a dry powder.

Other plant regulatory molecules, in addition to auxin and its analogs, can be used to reduce nicotine and/or nitrosamine levels in tobacco. The synthesis and accumulation of nicotine and other tobacco alkaloids is known to be controlled by the signaling pathways triggered by various developmental, environmental, and chemical cues. Mechanical wounding, insect herbivory or animal herbivory often induce a wound response in plants involving the signal molecule of jasmonic acid. A general review of jasmonic acid may be found in Staswick, “Jasmonate Activity in Plants,” Plant Hormones, P. J. Davies (ed.), Kluwer Academic Publishers, pp. 179-187 (1995). The plant regulatory molecules involved in these signaling pathways exhibit cross talk with other signaling pathways to create complex responses. For a review of the various interacting signaling pathways involved in the wound response and jasmonic acid accumulation. (See Walling, J. Plant Growth Regul., 19:195 (2000)). For example, cross talk between jasmonate and salicylic acid pathways has been found in lima bean (Engelberth et al., Plant Physiol., 125:369 (2001)). Further, the plant regulatory molecule ethylene has been found to interact with jasmonate to alter nicotine levels in Nicotiana attenuata (Winz, et al., Plant Physiol., 125:2189 (2001)). It was also found that inoculation of tobacco with tobacco mosaic virus (TMV) creates plants that are unable to have normal wound responses. This finding is thought to involve cross talk between the pathogen-induced salicylic acid pathway and the wound-induced jasmonic acid pathway (Preston, et al., Planta, 209:87 (1999)).

Cocktails of Auxins, Auxin Analogs, and/or Jasmonate Antagonists

In addition to using an auxin, auxin analog, or jasmonate antagonist, a mixture or “cocktail” of two or more nicotine and/or nitrosamine reducing agents can be used. In such a cocktail, auxins, auxin analogs, and/or jasmonate antagonists can be used together as a single mixture to be used in one or more applications to the plant. Alternatively, the content of a mixture can be varied such that different compositions are applied to the tobacco plant over the course of the treatment. In many embodiments, the range of auxin, auxin analog, and/or jasmonate antagonist in the cocktail will be between about 0.005 ppm and about 200 ppm. That is, the amount of auxin, auxin analog, or jasmonate antagonist in various combinations can be about: 0.005 ppm, 0.007 ppm, 0.01 ppm, 0.02 ppm, 0.05 ppm, 0.07 ppm, 0.1 ppm, 0.2 ppm, 0.5 ppm, 0.7 ppm, 1 ppm, 2 ppm, 5 ppm, 7 ppm, 10 ppm, 20 ppm, 50 ppm, 75 ppm, 100 ppm, 125 ppm, 150 ppm, 175 ppm, or 200 ppm or more for each auxin, auxin analog, and/or jasmonate antagonist component of the cocktail. The section below describes the topping and timing of application of auxin, auxin analog, and jasmonate antagonist or cocktails thereof in greater detail.

Topping and Timing of Treatment

In tobacco, the agricultural process of topping the tobacco plants before harvesting plays a key role in the regulation of nicotine levels. The mechanical wounding of the tobacco plant due to topping induces production of jasmonic acid, which in turn stimulates production of nicotine, a substrate for nitrosamines. Additionally, topping of tobacco removes cells of the plant that produce auxins, which down regulate nicotine production. In consequence, the topping process spikes nicotine levels in the plant. Topping is advantageous for other reasons, however. Topping encourages vegetative growth which increases crop yield and prevents seeding of the plants. Thus, by practicing the methods described herein, tobacco plants can be topped without causing a spike in nicotine, which occurs as a result of removal of the auxin source and production of jasmonic acid. That is, tobacco crops can be topped and treated with an auxin, auxin analog or jasmonate antagonist, preferably a cocktail of one or more auxins, auxin analogs, or jasmonate antagonists, in the field thereby producing harvestable tobacco from which a reduced nicotine and/or nitrosamine tobacco product can be generated.

In many embodiments, the auxin, auxin analog, jasmonate antagonist, or cocktail thereof is applied to the plant when the plant is at the mature stage of growth, that is shortly before and/or after harvest. Desirably, the auxin, auxin analog, jasmonate antagonist is added just prior to wounding the plant (e.g., topping or decapitation) and thereafter so as to prevent the wounding response by the tobacco plant. Because auxin levels drop considerably within the first six hours after wounding a tobacco plant, it is preferred that auxin, auxin analog, jasmonate antagonist treatment accompanies topping in the field. (See e.g., Thomberg et al., Plant Physiol. 96:802 (1991)). It should be understood, however, that treatment with auxin, auxin analog, jasmonate antagonist can be performed about 21 days to up to one month prior to topping, the day of topping, to about 21 days after topping and up to the day of harvest. In some embodiments, treatment may occur after harvest.

That is, the auxin, auxin analog, jasmonate antagonist, or cocktail thereof can be added about: 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, and/or about 31 days before harvest or the day of topping or 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, and/or 31 days before harvest. Likewise the auxin, auxin analog, jasmonate antagonist, or cocktail thereof can be added about: 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, and/or about 31 days before harvest or the day of topping or 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, and/or 31 days after topping. The auxin, auxin analog, jasmonate antagonist, or cocktail thereof may also be applied earlier and, in some cases, after harvest. The concentration of auxin, auxin analog, jasmonate antagonist, or cocktail thereof required is determined empirically, as factors such as plant age, variety, sensitivity, and presence of environmental stresses can have an affect on the response.

The auxins, auxin analog, jasmonate antagonist, or cocktail thereof can be applied once before harvest, every day before harvest, or at any frequency in between. The application of auxins, auxin analogs, jasmonate antagonists, or cocktail therof can also take place after topping the plant, typically up to 31 days after topping, preferably the day of topping. The auxins, auxin analog, jasmonate antagonist, or cocktail thereof can also be applied once after topping, every day after topping, or at any frequency in between.

The auxin, auxin analog, jasmonate antagonist, or cocktail thereof may be contacted with tobacco plants that are already relatively low in nicotine levels. Varieties of tobacco that have low nicotine levels can be used. Additionally, genetic engineering has been used to decrease levels of enzymes involved in the nicotine biosynthetic pathway, resulting in low nicotine tobacco plants that can be used with embodiments of this invention. A preferred embodiment is the genetically modified tobacco Vector 2141, which was created using antisense disruption of the QPTase gene. See, e.g., WO 9856923, WO 0067558, and PCT/US01/26788. The section below describes the harvest of the treated tobacco and the preparation of tobacco products therefrom.

Harvest and Preparation of Products

The tobacco treatments, as described herein, are suitable for use with conventional growing and harvesting techniques (e.g. topping or no topping, bagging the flowers or not bagging the flowers, cultivation in manure rich soil or without manure) and the harvested leaves and stems are suitable for use in any traditional preparation including cutting, drying, curing, fermenting and manufacturing traditional tobacco products for sale including, but not limited to, pipe, cigar and cigarette tobacco, chewing tobacco in any form including leaf tobacco, shredded tobacco, or cut tobacco, and tobacco-containing gums or lozenges. It is also contemplated that the low nicotine and/or nitrosamine tobacco described herein can be processed and blended with conventional tobacco so as to create a wide-range of tobacco products with varying amounts of nicotine and/or nitrosamines. These blended tobacco products can be used in tobacco product cessation programs so as to slowly move a consumer from a high nicotine and nitrosamine product to a low nicotine and nitrosamine product.

For example, a smoker can begin the program smoking blended cigarettes having 10 mg of nicotine and 1.5 mg of nitrosamine, gradually move to smoking cigarettes with 7 mg of nicotine and 1 mg of nitrosamine, followed by cigarettes having 5.0 mg nicotine and 0.5 mg nitrosamine, followed by cigarettes having 2.0 mg nicotine and 0.25 mg nitrosamine, followed by cigarettes having 1.0 mg nicotine and no nitrosamine until the consumer decides to smoke only the cigarettes having virtually no nicotine and nitrosamines or quitting smoking altogether. Accordingly, the blended cigarettes described herein provide the basis for an approach to reduce the carcinogenic potential in a human in a step-wise fashion.

As used herein, a crop comprises a plurality of plants of the present invention, and of the same genus, planted together in an agricultural field. By “agricultural field” is meant a common plot of soil or a greenhouse. Thus, the present invention provides a method of producing a crop of plants treated with auxin, auxin analogs, or jasmonate antagonists, and thus having decreased nicotine and/or nitrosamine levels, as compared to a similar crop of non-treated plants of the same species and variety. The examples which follow are set forth to illustrate the present invention, and are not to be construed as limiting thereof.

### EXAMPLE 1

### Reduction of Nicotine and Nitrosamine Levels in Tobacco by Using 2,4-D

To reduce the level of nicotine and/or nitrosamine in a cultivated crop or field of tobacco, a concentrated solution of 2,4-D in water (e.g., a 10% solution) with the wetting agent “Agral 60” (e.g., a 0.0006% v/v miscible oil emulsion) is prepared. A control solution containing the wetting agent without 2,4-D is also prepared. These solutions are diluted to 0.1, 1, 10, or 100 ppm of 2,4-D in the final spray solution. Control and experimental fields of tobacco (e.g., Burley, Virginia Flue, and Oriental varieties in separate test plots cultivated by conventional techniques for the particular varieties) at various ages of maturity (some of which have been topped) are sprayed with parallel dilutions of the wetting agent alone. Plants are then sprayed with the above solutions to the dripping-off point. Plants are allowed to continue growing normally for 14 days. Plants are then harvested and sample leaves (from the same position on the plants of the same age) are quick-frozen using liquid nitrogen. Nicotine levels are measured on these sample leaves using standard techniques.

A quick drying curing technique or a conventional curing technique particular to the variety being tested is employed to obtain cured leaves (non-green or yellow dried leaves). Conventional TSNA analysis is then performed on the cured leaves and stems and/or portions thereof (e.g., lamina and midrib of the leaf). By following this approach, the amount of 2,4-D to apply to a specific variety of tobacco, for a specific age of plant (topped or not topped) in the field to achieve a reduced nicotine and/or nitrosamine level is readily determined. In the following example, ethylene precursors, such as ethephon, are used to decrease jasmonate-induced nicotine and/or nitrosamine levels in tobacco.

### EXAMPLE 2

### Reduction of Nicotine and Nitrosamine Levels in Tobacco Using Ethephon

Control and experimental fields of tobacco (e.g., Burley, Virginia Flue, and Oriental varieties in separate test plots cultivated by conventional techniques for the particular varieties) at various ages of maturity (some of which have been topped) are grown. Some of the untopped plants are treated with either methyl jasmonate (MeJA) alone, or with MeJA and ethephon and the topped plants are treated with etephon. Varying amounts of MeJA and etephon are applied and “Agral 60”, prepared as in Example 1, is used with some of the experimental plots. Plants are harvested 1, 2, 3, 4, and 5 days after treatment. Sample leaves are quick frozen with liquid nitrogen and the nicotine concentration (μg/mg dry weight) is determined on the sample leaves. A quick drying curing technique or a conventional curing technique particular to the variety being tested is employed to obtain cured leaves (non-green or yellow dried leaves). Conventional TSNA analysis is then performed on the cured leaves and stems and/or portions thereof (e.g., lamina and midrib of the leaf). By following the approach described above, the amount of etephon to apply to a specific variety of tobacco, for a specific age of plant (topped or not topped) in the field to achieve a reduced nicotine and/or nitrosamine level is readily determined. In the following example, Benzo[1,2,3]thiadiazole-7-carbothioic acid containing compounds are used to decrease jasmonate-induced nicotine and/or nitrosamine levels in tobacco.

### EXAMPLE 3

### Reduction of Nicotine and Nitrosamine Levels in Tobacco Using Benzo[1,2,3]thiadiazole-7-carbothioic Acid

Control and experimental fields of tobacco (e.g., Burley, Virginia Flue, and Oriental varieties in separate test plots cultivated by conventional techniques for the particular varieties) at various ages of maturity (some of which have been topped) are grown. The Benzo[1,2,3]thiadiazole-7-carbothioic acid containing compound Actigard is applied to tobacco fields, according to the manufacturer's instructions, in various dilutions. At 5, 10, 14, and 21 days after treatment tobacco is harvested and sample leaves are quick frozen in liquid nitrogen. The sample leaves are analyzed for nicotine levels using conventional assays. Harvested stems and leaves are either cured using a quick drying method or are conventionally cured using a curing technique particular to the variety being tested so as to obtain cured leaves (non-green or yellow dried leaves). Conventional TSNA analysis is then performed on the cured leaves and stems and/or portions thereof (e.g., lamina and midrib of the leaf). By following the approach described above, the amount of Benzo[1,2,3]thiadiazole-7-carbothioic acid to apply to a specific variety of tobacco, for a specific age of plant (topped or not topped) in the field to achieve a reduced nicotine and/or nitrosamine level is readily determined. In the following example, a cocktail of 2,4-D and a Benzo[1,2,3]thiadiazole-7-carbothioic acid containing compound is used to decrease jasmonate-induced nicotine and/or nitrosamine levels in tobacco.

### EXAMPLE 4

### Reduction of Nicotine and Nitrosamine Levels in Tobacco Using 2,4-D and Benzo[1,2,3]thiadiazole-7-carbothioic Acid

Control and experimental fields of tobacco (e.g., Burley, Virginia Flue, and Oriental varieties in separate test plots cultivated by conventional techniques for the particular varieties) at various ages of maturity (some of which have been topped) are grown. Solutions of 2,4-D (at various dilutions) with and without Agral 60 are prepared, as described in Example 1. The Benzo[1,2,3]thiadiazole-7-carbothioic acid containing compound Actigard is prepared according to the manufacturer's instructions. Experimental plots (topped and untopped) are sprayed with 2,4-D and are subsequently sprayed with Actigard. At 5, 10, 14, and 21 days after treatment tobacco is harvested and sample leaves are quick frozen in liquid nitrogen. The sample leaves are analyzed for nicotine levels using conventional assays. Harvested stems and leaves are either cured using a quick drying method or are conventionally cured using a curing technique particular to the variety being tested so as to obtain cured leaves (non-green or yellow dried leaves). Conventional TSNA analysis is then performed on the cured leaves and stems and/or portions thereof (e.g., lamina and midrib of the leaf). By following the approach described above, the amount of 2,4-D in combination with Benzo[1,2,3]thiadiazole-7-carbothioic acid to apply to a specific variety of tobacco, for a specific age of plant (topped or not topped) in the field to achieve a reduced nicotine and/or nitrosamine level is readily determined. In the following example, the production of low nicotine and low nitrosamine tobacco blends is described.

### EXAMPLE 5

### Low Nicotine and Nitrosamine Blended Tobacco

The following example describes several ways to create tobacco products having specific amounts of nicotine and/or TSNAs through blending. Some blending approaches begin with tobacco prepared from varieties that have extremely low amounts of nicotine and/or TSNAs. By blending prepared tobacco from a low nicotine/TSNA variety (e.g., undetectable levels of nicotine and/or TSNAs) with a conventional tobacco (e.g., Burley, which has 30,000 ppm nicotine and 8,000 parts per billion (ppb) TSNA; Flue-Cured, which has 20,000 ppm nicotine and 300 ppb TSNA; and Oriental, which has 10,000 ppm nicotine and 100 ppb TSNA), tobacco products having virtually any desired amount of nicotine and/or TSNAs can be manufactured. Tobacco products having various amounts of nicotine and/or TSNAs can be incorporated into tobacco-use cessation kits and programs to help tobacco users reduce or eliminate their dependence on nicotine and reduce the carcinogenic potential.

For example, a step 1 tobacco product can be comprised of approximately 25% low nicotine/TSNA tobacco and 75% conventional tobacco; a step 2 tobacco product can be comprised of approximately 50% low nicotine/TSNA tobacco and 50% conventional tobacco; a step 3 tobacco product can be comprised of approximately 75% low nicotine/TSNA tobacco and 25% conventional tobacco; and a step 4 tobacco product can be comprised of approximately 100% low nicotine/TSNA tobacco and 0% conventional tobacco. A tobacco-use cessation kit can comprise an amount of tobacco product from each of the aforementioned blends to satisfy a consumer for a single month program. That is, if the consumer is a one pack a day smoker, for example, a single month kit would provide 7 packs from each step, a total of 28 packs of cigarettes. Each tobacco-use cessation kit would include a set of instructions that specifically guide the consumer through the step-by-step process. Of course, tobacco products having specific amounts of nicotine and/or TSNAs would be made available in conveniently sized amounts (e.g., boxes of cigars, packs of cigarettes, tins of snuff, and pouches or twists of chew) so that consumers could select the amount of nicotine and/or TSNA they individually desire. There are many ways to obtain various low nicotine/low TSNA tobacco blends using the teachings described herein and the following is intended merely to guide one of skill in the art to one possible approach.

To obtain a step 1 tobacco product, which is a 25% low nicotine/TSNA blend, prepared tobacco from an approximately 0 ppm nicotine/TSNA tobacco can be mixed with conventional Burley, Flue-cured, or Oriental in a 25%/75% ratio respectively to obtain a Burly tobacco product having 22,500 ppm nicotine and 6,000 ppb TSNA, a Flue-cured product having 15,000 ppm nicotine and 225 ppb TSNA, and an Oriental product having 7,500 ppm nicotine and 75 ppb TSNA. Similarly, to obtain a step 2 product, which is 50% low nicotine/TSNA blend, prepared tobacco from an approximately 0 ppm nicotine/TSNA tobacco can be mixed with conventional Burley, Flue-cured, or Oriental in a 50%/50% ratio respectively to obtain a Burly tobacco product having 15,000 ppm nicotine and 4,000 ppb TSNA, a Flue-cured product having 10,000 ppm nicotine and 150 ppb TSNA, and an Oriental product having 5000 ppm nicotine and 50 ppb TSNA. Further, a step 3 product, which is a 75%/25% low nicotine/TSNA blend, prepared tobacco from an approximately 0 ppm nicotine/TSNA tobacco can be mixed with conventional Burley, Flue-cured, or Oriental in a 75%/25% ratio respectively to obtain a Burly tobacco product having 7,500 ppm nicotine and 2,000 ppb TSNA, a Flue-cured product having 5,000 ppm nicotine and 75 ppb TSNA, and an Oriental product having 2,500 ppm nicotine and 25 ppb TSNA.

It should be appreciated that tobacco products are often a blend of many different types of tobaccos, which were grown in many different parts of the world under various growing conditions. As a result, the amount of nicotine and TSNAs will differ from crop to crop. Nevertheless, by using conventional techniques one can easily determine an average amount of nicotine and TSNA per crop used to create a desired blend. By adjusting the amount of each type of tobacco that makes up the blend one of skill can balance the amount of nicotine and/or TSNA with other considerations such as appearance, flavor, and smokability. In this manner, a variety of types of tobacco products having varying level of nicotine and/or nitrosamine, as well as, appearance, flavor and smokeability can be created.

### EXAMPLE 6

### Smoking Cessation Product Containing Low Nicotine and Nitrosamine Levels

The following example describes a smoking cessation product utilizing the low nicotine, low TSNA tobacco products of the present invention. The treated tobacco containing very low levels of TSNAs and essentially no nicotine is mixed with synthetically prepared nicotine to create specific, stepwise levels of nicotine per cigarette. As an example, cigarettes may contain 5 mg, 4, 3, 2, 1, 0.5, 0.1, or 0 mg of nicotine per cigarette. The stepwise packs of cigarettes are clearly marked as to their nicotine content, and the step in the stepwise nicotine reduction program is also clearly marked on the package. Each week, the user purchases packs containing cigarettes having the next lower level of nicotine, but limits himself to no more cigarettes per day than consumed previously. The user may define his/her own rate of smoking cessation according to individual needs by choosing a) the number of cigarettes smoked per day b) the starting nicotine levels c) the change in nicotine level per cigarette each week, and d) the final level of nicotine consumed per day. To keep better track of the nicotine reduction program, the individual keeps a daily record of total nicotine intake, as well as the number of cigarettes consumed per day. Eventually, the individual will be consuming tobacco products with essentially no nicotine. Since the nicotine-free tobacco products of the final step are non-addictive, it should then be much easier to quit the use of the tobacco products altogether.

### EXAMPLE 7

### Smoking Cessation Kit Containing Packs of Cigarettes with Low TSNA Levels and Stepwise Reductions in Nicotine Levels

Various smoking cessation kits are prepared, geared to heavy, medium, or light smokers. The kits provide all of the materials needed to quit smoking in either a two-week period (fast), a one-month period (medium) or in a two-month period (slow), depending on the kit. Each kit contains a set number of packs of cigarettes prepared according the present invention, containing either 5 mg, 4, 3, 2, 1, 0.5, 0.1, or 0 mg of nicotine per cigarette. For example, 1 pack a day smokers would receive 7 packs of cigarettes, each pack containing the above amounts of nicotine per each cigarette. Several weeks worth of additional cigarettes containing 0 mg/cigarette would also be provided in the kit, to familiarize the consumer with smoking no nicotine cigarettes. The kit would also contain a diary for keeping track of daily nicotine intake, motivational literature to keep the individual motivated to continue with the cessation program, health information on the benefits of smoking cessation, and web site addresses to find additional anti-smoking information, such as chat groups, meetings, newsletters, recent publications, and other pertinent links.

Although the invention has been described with reference to embodiments and examples, it should be understood that various modifications can be made without departing from the spirit of the invention.

1. A method of making a reduced nicotine tobacco plant comprising:
identifying a tobacco plant in a field for nicotine reduction; and
contacting said tobacco plant with a composition selected from the group consisting of an auxin, auxin analog, and jasmonate antagonist from between about 21 days before topping to about 21 days after topping said tobacco plant, whereby the amount of nicotine in said topped tobacco plant contacted with said composition is below that of a topped tobacco plant of the same variety, grown under the same conditions, which has not been contacted with said composition.

2. A reduced nicotine tobacco plant made by the method of claim 1.

3. A method of making cured, reduced nicotine tobacco comprising:
identifying a tobacco plant in a field for nicotine reduction;
contacting said tobacco plant with a composition selected from the group consisting of an auxin, auxin analog, and jasmonate antagonist from between about 21 days before topping to about 21 days after topping said tobacco plant;
harvesting said tobacco plant; and
curing the tobacco of said harvested tobacco plant, whereby the amount of nicotine in said cured tobacco is below that of cured tobacco from a topped tobacco plant of the same variety, grown under the same conditions, which has not been contacted with said composition.

4. A cured, reduced nicotine tobacco made by the method of claim 3.

5. A method of making a cured tobacco with a reduced amount of a tobacco specific nitrosamine (TSNA) comprising:
identifying a tobacco plant in a field for nitrosamine reduction;
contacting said tobacco plant with a composition selected from the group consisting of an auxin, auxin analog, and jasmonate antagonist from between about 21 days before topping to about 21 days after topping said tobacco plant, whereby the amount of nicotine in said topped tobacco plant contacted with said composition is below that of a topped tobacco plant of the same variety, grown under the same conditions, which has not been contacted with said composition;
harvesting said topped tobacco plant that was contacted with said composition; and
curing the tobacco of said harvested tobacco plant, whereby the amount of a TSNA in said cured tobacco is below that of cured tobacco of a topped tobacco plant of the same variety, grown under the same conditions, which has not been contacted with said composition.

6. A cured tobacco with a reduced amount of a tobacco specific nitrosamine (TSNA) made by the method of claim 5.

7. A tobacco product made from the cured, reduced nicotine tobacco of claim 4.

8. A tobacco product made from the cured tobacco with a reduced amount of a tobacco specific nitrosamine (TSNA) of claim 5.

9. A method to withdraw from nicotine consumption while maintaining tobacco use comprising providing the tobacco product of claim 7 to a person seeking to withdraw from nicotine consumption while maintaining tobacco use for a time sufficient for said person to withdraw from nicotine consumption.

10. A method of reducing the toxic effects of nicotine in a person that consumes tobacco comprising providing a tobacco consumer the tobacco product of claim 7.

11. A method of reducing the exposure to tobacco specific nitrosamines (TSNAs) in a person that consumes tobacco comprising providing a tobacco consumer the tobacco product of claim 8.

12. A method of reducing the toxic effects of nicotine in a person that consumes tobacco comprising:
providing a tobacco consumer the tobacco product of claim 7, wherein said tobacco product is provided in at least two compositions: (a) a first composition of blended tobacco comprising an amount of nicotine below the level of nicotine found in tobacco produced from said untreated tobacco plant but an amount of nicotine above the level of nicotine, which produces addiction; and (b) a second composition of tobacco comprising an amount of nicotine below the level of nicotine, which produces addiction; and
instructing said tobacco consumer to consume the first composition for a time sufficient to reduce the use of conventional tobacco products; and
instructing said tobacco consumer to consume the second composition for a time sufficient to reduce the use of said first composition, whereby said toxic effects of nicotine are reduced.

13. A method of treating a tobacco plant to reduce the amount of nicotine comprising:
contacting a tobacco plant of a first variety with at least one composition comprising an agent selected from the group consisting of an auxin, auxin analog, and jasmonate antagonist, wherein the contacting occurs from between about 21 days before topping to about 21 days after topping; and
obtaining a leaf of said tobacco plant, the leaf having a level of nicotine that is lower than a level of nicotine in a similar leaf of a topped plant of the same variety, cultivated under the same growing conditions, not contacted with the composition.

14. The method of claim 13, wherein the contacting step is repeated.

15. The method of claim 14, wherein said tobacco plant is contacted with a plurality of agents selected from the group consisting of auxin, auxin analog, or jasmonate antagonist.

16. The method of claim 14, wherein said tobacco plant is a Virginia Flue variety, an Oriental variety, or a Burley variety.

17. The method of claim 14, wherein said tobacco plant is a genetically modified tobacco plant.

18. The method of claim 16, wherein said genetically modified plant is Vector 21-41.

19. A topped tobacco plant treated with an auxin or an auxin analog, wherein the amount of auxin in a leaf of said topped tobacco plant two days after topping is between about 5 and about 40 ng/g fresh weight.

20. The topped tobacco plant of claim 19, wherein the amount of auxin in said leaf of said topped tobacco plant is between about 10 and about 40 ng/g fresh weight.

21. The topped tobacco plant of claim 19, wherein the amount of auxin in said leaf of said topped tobacco plant is between about 15 and about 40 ng/g fresh weight.

22. The topped tobacco plant of claim 19, wherein the amount of auxin in said leaf of said topped tobacco plant is between about 20 and about 40 ng/g fresh weight.

23. The topped tobacco plant of claim 19, wherein the amount of auxin in said leaf of said topped tobacco plant is between about 25 and about 40 ng/g fresh weight.

24. The topped tobacco plant of claim 19, wherein the amount of auxin in said leaf of said topped tobacco plant is between about 30 and about 40 ng/g fresh weight.

25. The topped tobacco plant of claim 19, wherein the amount of auxin in said leaf of said topped tobacco plant is between about 35 and about 40 ng/g fresh weight.
